(19) United States
(12) Patent Application Publication
(10) Pub. No.: US 2006/0125434 A1
(43) Pub. Date: Jun. 15, 2006

(54) Converter for a motor vehicle

(75) Inventors: Hans-Joachim Frohne, Lehre (DE); Andreas Klinkig, Cremlingen (DE); Ralf Borngraber, Wolfsburg (DE)

Correspondence Address: LERNER GREENBERG STEMER LLP, P O BOX 2480, HOLLYWOOD, FL, 33022-2480, US

(73) Assignee: Volkswagen Aktiengesellschaft

(21) Appl. No.: 11/348,112

(22) Filed: Feb. 6, 2006

Related U.S. Application Data
(63) Continuation of application No. PCT/EP04/07130, filed on Jun. 30, 2004.

(30) Foreign Application Priority Data
Aug. 6, 2003 (DE) 103 35 866.8

(51) Int. Cl. H02P 5/00

(52) U.S. Cl. 318/139

(57) ABSTRACT

An automotive frequency converter is connected to at least one load socket. The electrical converter is switched to an operational state by inserting an electrical load plug in the load socket.

### CROSS-REFERENCE TO THE RELATED APPLICATION

This is a continuing application, under 35 U.S.C. § 120, of copending international application PCT/EP2004/007130, filed Jun. 30, 2004, which designated the United States; this application also claims the priority, under 35 U.S.C. § 119, of German patent application DE 103 35 866.8, filed Aug. 6, 2003; the prior applications are herewith incorporated by reference in their entirety.

### BACKGROUND OF THE INVENTION

### Field of the Invention

The invention lies in the field of automotive technology. More specifically, the invention relates to a converter for a motor vehicle, having at least one load socket. Modern motor vehicles have a large number of electrical components which provide a large number of comfort and safety functions for the driver of the vehicle and for other occupants. If the vehicle occupants wish to connect additional electrical devices to the motor vehicle electrical system, they usually have to use the operating voltage prevailing in this electrical system. In this case, electrical devices are known which have a connection plug that is inserted into a cigarette lighter, for example, and thus produces an electrical power supply for the additional devices.

It is not critical if the vehicle occupants touch live parts because the voltage level is relatively low. However, if devices with a relatively high voltage (DC or AC voltage) are operated in the vehicle, protective measures have to be taken to prevent vehicle occupants from unintentionally touching the live parts. A child protection means is also expedient in that case.

German utility model DE 91 11 135 U1 (Gebrauchsmuster) describes a child protection device in protective contact sockets. In this case, switching elements are triggered by means of contact pins and connect the electrical power supply to the plug-in contacts by inserting the connector.

German published patent application DE 33 43 270 A1 discloses a switchable single-phase AC voltage socket, having a conductor socket and neutral conductor socket, which is arranged in a socket base, it being possible to apply a system voltage to the socket by means of a closable switching contact. In this case, the system voltage is connected as a function of a resistance threshold value being undershot, whereas it is not connected if this threshold value is exceeded.

### SUMMARY OF THE INVENTION

It is accordingly an object of the invention to provide a motor vehicle frequency converter, which overcomes the above-mentioned disadvantages of the heretofore-known devices and methods of this general type and which converter is made ready for operation only after a load connector is inserted into a load socket.

With the foregoing and other objects in view there is provided, in accordance with the invention, an electrical converter assembly for a motor vehicle, comprising:

an electrical converter for the motor vehicle;

at least one load socket configured to receive an electrical load connector and to render said electrical converter ready for operation when the electrical load connector is inserted into said load socket.

The fact that the converter for a motor vehicle can be made ready for operation only by inserting an electrical load connector into the load socket produces a number of advantages. In the following text, a converter for a motor vehicle is to be understood as an inverter and/or rectifier and/or step-up converter and/or step-down converter which can convert, for example, one or more different voltages into one or more other voltages which may also have a different frequency and/or voltage level and/or voltage waveform.

Since the converter for a motor vehicle is made ready for operation only when the load connector is inserted, there is therefore a lower electrical power loss in the converter. Idling losses are consequently minimized and the cooling measures required can therefore be reduced. The converter is available in the motor vehicle for a longer period of time since the service life is also calculated as a function of its readiness for operation, amongst other things.

It is advantageous for the converter for a motor vehicle or for the load socket to have means for sensing an electrical load, it being possible to make the converter for a motor vehicle ready for operation when an electrical load which is connected to the converter for a motor vehicle is sensed. It is thus possible to detect electrical loads by inductive, capacitive or resistive sensing means, for example. A child may be protected, for example, by the converter for a motor vehicle being made ready for operation only when there is a specific capacitive, inductive or resistive load threshold.

It is also advantageous when the converter can be made ready for operation by an operating mechanism in the load socket, it being possible to trigger this operating mechanism by inserting the load connector. This makes it possible to easily connect the converter for a motor vehicle by mechanical operation.

Mechanically operated protection against the electrical contacts being touched is additionally ensured by the fact that the electrical contacts of the load socket can be covered and/or exposed by the operating mechanism.

A further advantageous development of the invention is provided in that an electrical actuating circuit of the converter for a motor vehicle can be activated by the operating mechanism and/or the means for sensing an electrical load. The load current is consequently not interrupted directly by the load connector, but indirectly and, for example, with a relay or a semiconductor switching element. In this case, the actuating circuit may be arranged in the converter for a motor vehicle itself, or outside this converter.

It is possible to adapt the converter for a motor vehicle to different input and output voltages on account of the fact that at least one DC voltage can be converted into at least one AC voltage by the converter for a motor vehicle.

In accordance with an additional feature of the invention, the AC output voltage may be set to international rated AC voltages, in particular 230 V, 115 V and 100 V. This allows motor vehicles with converters for motor vehicles to be used in countries which have different power supply rated voltages. The converter for a motor vehicle should be set only to the rated voltage when a different rated output voltage is required. In this case, it may be advantageous if the load socket is either of universal design, so that it can receive a plurality of connector shapes, or is exchangeable.

Other national conditions of the power supply network, in particular the rated frequency, can be set on account of the fact that the rated frequency of the AC voltage can be set to 50 Hz or 60 Hz.

One advantageous development of the invention is that the converter for a motor vehicle can be switched on and/or off by a supply network state recognition device. If the battery voltage of the motor vehicle (input voltage) can provide little power, the supply network state recognition device recognizes, on account of a falling supply voltage for example, that the power supply is no longer ensured and switches off the converter for a motor vehicle. The supply network state recognition device can switch on the converter for a motor vehicle again when the battery voltage has again reached predefined values. The supply network state recognition device can also switch off the converter for a motor vehicle after the engine is stopped and/or after a predefined time.

A further protective measure of the converter for a motor vehicle is that the converter for a motor vehicle can be switched off when there is an overvoltage or undervoltage in the supply network. Damage to the connected electrical load or to the converter for a motor vehicle or to the supply network can therefore be prevented.

For signalling purposes, it is advantageous for the converter for a motor vehicle and/or for the supply network state recognition device to have an optical or acoustic signalling system. A user can therefore immediately establish whether a converter for a motor vehicle has been switched off. In some circumstances, it is also feasible for the signalling system to be used with variable intensity within a predefined time before the converter is switched off, so that a user has enough time to safely switch off electrical loads.

It is also advantageous if the readiness of the converter for a motor vehicle to operate, or a supply network state, can be indicated by the signalling system. A user can therefore immediately identify whether he can successfully connect an electrical load to the converter for a motor vehicle.

A further advantageous refinement is provided in that an identification signal can be produced by the supply network state recognition device or by the converter for a motor vehicle and can be used to signal that the converter for a motor vehicle should be switched off. The identification signal can be transmitted to further devices by means of a data bus, for example, and used to coordinate the power budget of the motor vehicle. It is therefore possible, depending on priorities, to switch off electrical loads of the motor vehicle (for example fan, seat heater etc.) in order to thereby extend the actual switch-on time of the converter for a motor vehicle. It is also feasible to indicate that the converter should be switched off on the combination instrument of the instrument panel.

On account of the fact that the converter for a motor vehicle has means for overload identification, which means can be used to switch off the converter for a motor vehicle at least for the duration of an overload, the converter for a motor vehicle can advantageously be switched off for this state. The converter for a motor vehicle can also restrict the load to the rated load. This counteracts or prevents damage to the system.

The converter for a motor vehicle can advantageously be protected against overheating and thus against faulty operation and/or premature failure of the device by identifying an overtemperature. An overtemperature can also be reached by external influences, for example when there is a high temperature at the converter for a motor vehicle because of a high degree of solar radiation. This may result in the converter for a motor vehicle no longer being guaranteed to operate without fault even when a load lower than the rated load is connected. In this case, overload identification can advantageously be combined with overtemperature identification.

On account of the converter for a motor vehicle having at least one signal line to a motor vehicle controller or to a motor vehicle computer or to a motor vehicle display, other devices in the motor vehicle can be informed about the state of the converter for a motor vehicle and protective and/or warning measures (switching off consumers, displaying state data about the converter for a motor vehicle) may be taken.

Other features which are considered as characteristic for the invention are set forth in the appended claims.

Although the invention is illustrated and described herein as embodied in a converter for aq motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic block diagram of a converter for a motor vehicle according to the invention, having a power supply, a load socket, a signaling system, and signal lines;

FIG. 2 is a basic illustration of an activation mechanism of a converter for a motor vehicle; and

FIG. 3 is a sectional view of an activation mechanism of a converter for a motor vehicle.

### DESCRIPTION OF THE PREFERRED EMBODIMENTS

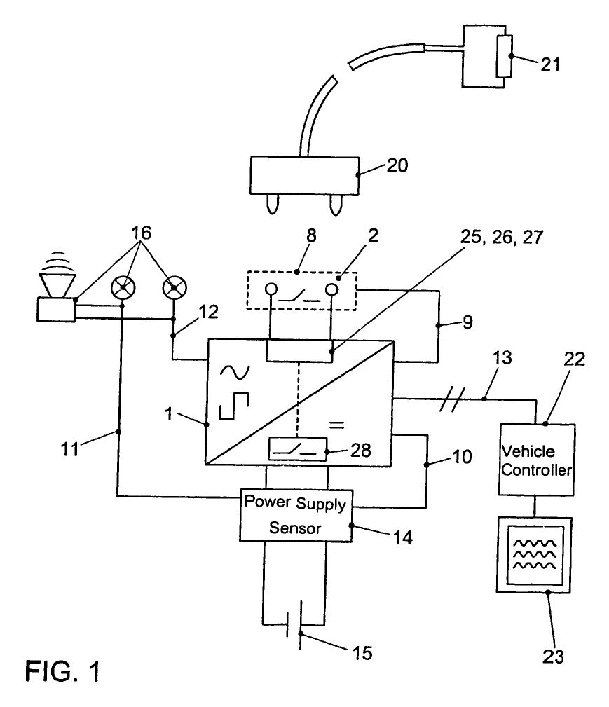

Referring now to the figures of the drawing in detail and first, particularly, to FIG. 1 thereof, there is shown a basic illustration of a converter 1 for a motor vehicle, having a power supply, load socket, signalling system and signal lines. In this case, the converter 1 for a motor vehicle is connected to a supply network state recognition device 14—a power supply sensor for short—via power supply lines (not illustrated in any great detail), the supply network state recognition device identifying undervoltages and overvoltages of a battery 15 or a supply network, for example. The battery 15 is usually fed by a non-illustrated generator of the motor vehicle. If the supply network state recognition device 14 identifies a critical state, it informs the converter 1 for a motor vehicle of this via a signal line 10. A signalling system 16 can also be actuated by the supply network state recognition device 14 via a signal line 11. A motor vehicle driver or else a motor vehicle controller 22 therefore constantly receives information about whether the supply network and the battery 15 are in a satisfactory state. The converter 1 for a motor vehicle may have its own signalling system 16 which can be actuated via a signal line 11, 12. In the satisfactory operating state, the converter 1 for a motor vehicle supplies an output voltage to the load socket 2 which may represent a DC or AC voltage or a superimposed DC voltage. It is also feasible for different output frequencies and rated output voltages to be set directly at the converter 1 for a motor vehicle or by means of a motor vehicle controller 22.

The converter 1 for a motor vehicle is made ready for operation via the signal line 9 if a mechanism or else means 25 for sensing an electrical load establish that an electrical load connector 20 has been inserted. The converter 1 for a motor vehicle thus first produces a power loss when an electrical load 21 is to be supplied with power. The invention prevents the converter 1 from unnecessarily producing a power loss when idling and thus unnecessarily loading the power supply circuit (the battery is discharged). The means 25 for sensing an electrical load, or the insertion of the load connector 20 ensures that electrical contacts 24 carry an electrical voltage only when operation is required (insertion of the load connector 20). It is therefore advantageous to provide a means for protecting against live parts of the motor vehicle being touched unintentionally. If the load socket 2 is situated in the rear part of the vehicle, it is easy for children to insert objects into the load socket 2. Dangerous electric shocks can be prevented since the converter 1 for a motor vehicle is not made ready for operation. The load socket 2 is reliably disconnected from the operating voltage (output voltage of the converter 1 for a motor vehicle).

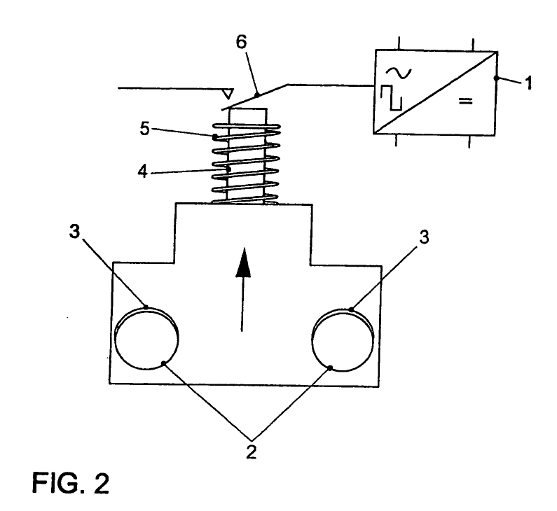

FIG. 2 shows a basic illustration of an activation mechanism of a converter 1 for a motor vehicle. If an electrical load connector 20 is inserted into the load socket 2, a protective cover 3 is mechanically moved in such a way that an operating mechanism 4 closes a switch 6. An instruction to prepare for operation is therefore transmitted to the converter 1 by way of an electrical signal. When the electrical load connector 20 is once more pulled out of the load socket 2, a spring 5 ensures that the operating mechanism 4 returns to its position. The protective cover 3 closes the load socket 2 in such a way that it is no longer possible to touch live parts from the outside. The switch 6 opens and causes the converter 1 for the motor vehicle to be switched off.

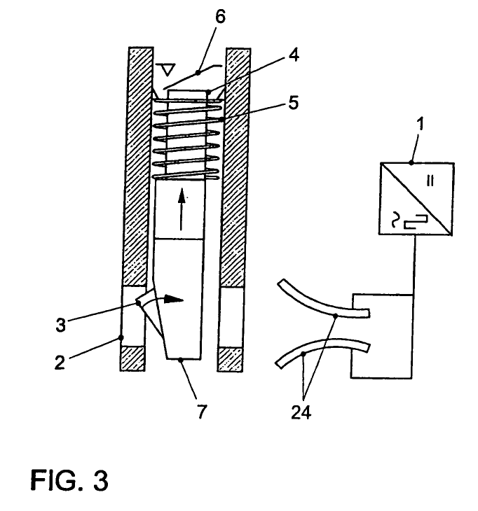

FIG. 3 shows a sectional view of the activation mechanism of a converter 1 for a motor vehicle. An electrical load connector 20 operates a protective cover 3 in such a way that a latching mechanism is pushed into the sliding pin 7, so that the sliding pin 7 in the load socket 2 can be moved in the direction of the arrow. A spring 5 is consequently loaded and the switch 6 is closed by means of an operating mechanism 4. The plug-in contacts 24 of the electrical load connector 20 can be pushed through openings in the load socket 2 after the sliding pin 7 moves. As said connector is inserted further, said plug-in contacts make electrical contact, as is known from customary sockets, and in this case are mechanically clamped. If the load connector 20 is pulled out of the load socket 2, electrical contact is broken and the sliding pin 7 is again pushed back, in the opposite direction to the arrow, to its starting position by the restoring force of the spring 5. If the latching mechanism in the protective cover 3 reaches openings in the load socket 2, it latches there and therefore locks the sliding pin 7. At the same time, an electrical connection is disconnected by the switch 6 and switches off the converter 1 for a motor vehicle by means of an actuating circuit 28 via a signal line (not illustrated). The battery voltage is therefore no longer converted and thus does not cause any electrical losses in the converter 1.

The converter 1 according to the invention may have two or more load sockets 2, and can be made ready for operation by inserting the first load connector 20. In this context, the term “ready for operation” means that the converter 1 for a motor vehicle produces an output voltage or applies the output voltage to the electrical contacts 24, or the converter 1 for a motor vehicle is supplied with electrical power in order to produce an output voltage.

The load socket 2 may be a constituent part of the motor vehicle converter 1, but it may also be connected to the converter by means of connection terminals, connection plugs, or the like. The latter situation may be advantageous particularly if the converter 1 for a motor vehicle has to be separated from the load socket 2 for reasons of space.

We claim:

1. An electrical converter assembly for a motor vehicle, comprising:
an electrical converter for a motor vehicle;
at least one load socket configured to receive an electrical load connector and to render said electrical converter ready for operation when the electrical load connector is inserted into said load socket.

2. The converter assembly according to claim 1, which comprises means for sensing an electrical load, connected and configured to render said converter ready for operation when an electrical load is sensed as being connected to said converter.

3. The converter assembly according to claim 1, which further comprises an operating mechanism in said load socket, wherein said operating mechanism is disposed in said load socket for triggering to render said converter ready for operation when the load connector is inserted into said load socket.

4. The converter assembly according to claim 3, wherein said operating mechanism is configured to selectively cover or expose electrical contacts of said load socket.

5. The converter assembly according to claim 3, wherein said converter includes an electrical actuating circuit to be activated by said operating mechanism and/or by said means for sensing an electrical load.

6. The converter assembly according to claim 1, wherein said converter of said motor vehicle is configured to convert at least one DC voltage into at least one AC voltage.

7. The converter assembly according to claim 6, wherein said converter is configured to set the AC voltage to a rated voltage of less than or equal to 230 V and a frequency of substantially 50 Hz.

8. The converter assembly according to claim 6, wherein said converter is configured to set the AC voltage to a rated voltage of less than or equal to 115 V and a frequency of substantially 60 Hz.

9. The converter assembly according to claim 6, wherein said converter is configured to set the AC voltage to a rated voltage of substantially 100 V and a frequency of 50 Hz or 60 Hz.

10. The converter assembly according to claim 1, which comprises a supply network state recognition device connected to selectively switch said converter for the motor vehicle on and off.

11. The converter assembly according to claim 10, wherein said converter for the motor vehicle is switched off when an overvoltage or an undervoltage exists in the supply network.

12. The converter assembly according to claim 10, which comprises an optical and/or acoustic signalling system forming a part of said converter and/or of said supply network state recognition device.

13. The converter assembly according to claim 12, wherein said signalling system is configured to indicate a readiness of said converter to operate, or a state of the supply network.

14. The converter assembly according to claim 10, wherein said supply network state recognition device or said converter for the motor vehicle is configured to generate an identification signal indicating that said converter should be switched off.

15. The converter assembly according to claim 1, wherein said converter for the motor vehicle has a device for overload identification configured to switch off said converter at least for a duration of an overload.

16. The converter assembly according to claim 1, wherein said converter for the motor vehicle has a device for overtemperature identification configured to switch off said converter at least for a duration of an overtemperature.

17. The converter assembly according to claim 1, wherein said converter for the motor vehicle has at least one signal line connected to a motor vehicle controller or to a motor vehicle computer or to a motor vehicle display.

18. In combination with an onboard electrical system of a motor vehicle, an electrical converter assembly connected in the onboard electrical system, the assembly comprising:
an electrical converter connected to a power supply of the motor vehicle for converting an onboard electrical supply voltage to an output voltage;
at least one load socket configured to receive an electrical load connector and to render said electrical converter ready for operation when the electrical load connector is inserted into said load socket.
